(19) United States
(12) Patent Application Publication
(10) Pub. No.: US 2024/0205787 A1
(43) Pub. Date: Jun. 20, 2024

(54) FLEXIBLE ROUTING CONTROL IN INTERNET PROTOCOL MULTIMEDIA SUBSYSTEM (IMS)

(71) Applicant: T-Mobile USA, Inc., Bellevue, WA (US)

(72) Inventors: Harikishore Allu Balan, Lynnwood, WA (US); Saqib Badar, Bellevue, WA (US)

(21) Appl. No.: 18/069,120

(22) Filed: Dec. 20, 2022

(51) Int. Cl. H04W 40/02; H04W 8/20

(52) U.S. Cl. CPC H04W 40/02; H04W 8/20; H04W 8/04

(57) ABSTRACT

Systems, methods, and devices that relate to flexible routing options for routing a communication to reduce or minimize the signaling overhead and delay that comes with the re-registration or invite procedures are disclosed. In one example aspect, a wireless communication method includes receiving, by a network node in a network, an unregistered request for a communication of a user device; determining, by the network node, a routing option based on routing options that are available to the communication of the user device; and routing, by the network node, the communication using the routing option.

### BACKGROUND

The Internet Protocol (IP) Multimedia Subsystem (IMS) is an architectural framework that uses the Session Initiation Protocol (SIP) protocol to initiate, maintain, and terminate real-time sessions that include voice, video and messaging applications. The IMS has evolved over time to provide fast, secure, and stable multimedia services to end users.

### BRIEF DESCRIPTION OF THE DRAWINGS

Detailed descriptions of implementations of the present technology will be described and explained through the use of the accompanying drawings.

FIG. 1 is a block diagram that illustrates a wireless communications system that can implement aspects of the present technology.

FIG. 2 illustrates an example architecture an Internet Protocol Multimedia Subsystem (IMS) network.

FIG. 3 is a sequence chart of an example circuit-switched (CS) retry call flow in accordance with one or more embodiments of the present technology.

FIG. 4 is a flow diagram of an example CS retry selection in accordance with one or more embodiments of the present technology.

FIG. 5 is a flowchart representation of a process or a method for wireless communication in accordance with one or more embodiments of the present technology.

FIG. 6A is a flowchart representation of a method for wireless communication in accordance with one or more embodiments of the present technology.

FIG. 6B is a flowchart representation of another method or a process of wireless communication in accordance with one or more embodiments of the present technology

FIG. 7 is a block diagram that illustrates components of a computing device.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The IP Multimedia Subsystem or IP Multimedia Core Network Subsystem (IMS) is a standardized architectural framework for delivering IP multimedia services, including but not limited to IP phone calls and messages. Network issues that occur within the IMS can cause certain network nodes to become unreachable, impacting service quality and end-user experience of the multimedia services provided by the IMS. For example, when network outage impacts certain network nodes, such as the Serving Call Session Control Function (S-CSCF), there is no clear way to promptly restore the Proxy Serving Call Session Control Function (P-CSCF) that the user device is attached to. Such restoration issues can lead to numerous call failures that can potentially impact millions of users.

Techniques are disclosed herein to providing flexible routing options for routing a communication, such as using circuit switched networks and/or existing binding information between a user device and a corresponding P-CSCF, when a network node becomes unreachable so as to reduce or minimize the signaling overhead and delays that comes with the re-registration or invite procedures. The flexible routing options can be included in a user profile associated with the user device provided by a home server configured to manage subscriber information. Alternatively, or in addition, the flexible routing options can be stored in a local cache of a network node or an external database that is easily accessible to the network node. The flexible routing options can enable prompt restoration of the routing of the communication and/or adoption of alternative routing choices, such as using the circuit switched network, thereby eliminating the need for unnecessary re-registration or invite procedures.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Wireless Communications System

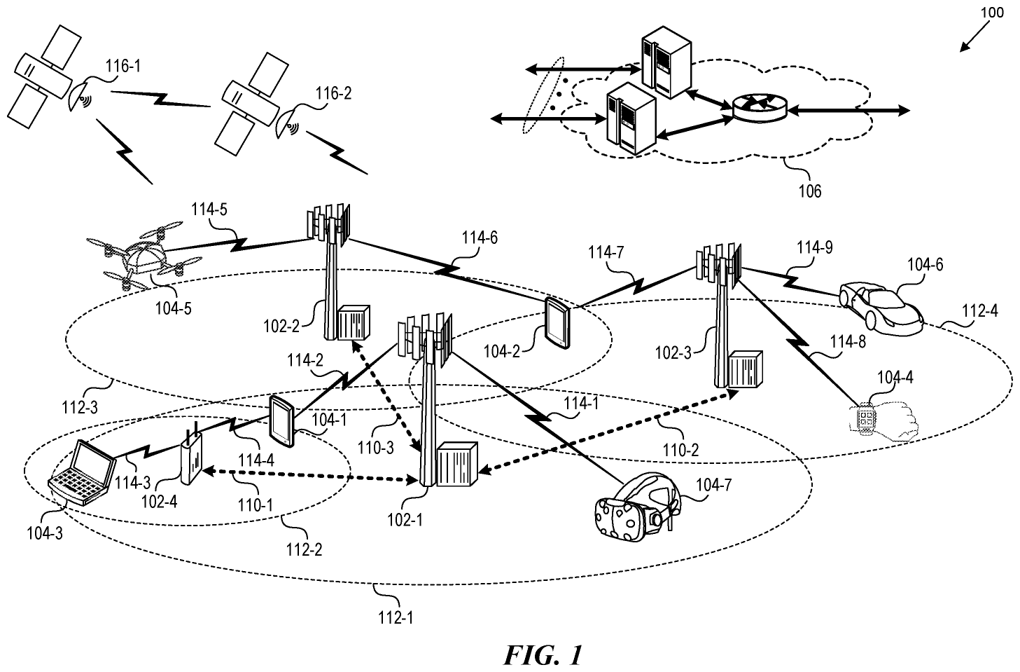

FIG. 1 is a block diagram that illustrates a wireless telecommunication network 100 (“network 100”) in which aspects of the disclosed technology are incorporated. The network 100 includes base stations 102-1 through 102-4 (also referred to individually as “base station 102” or collectively as “base stations 102”). A base station is a type of network access node (NAN) that can also be referred to as a cell site, a base transceiver station, or a radio base station. The network 100 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 802.11 access point.

The NANs of a network 100 formed by the network 100 also include wireless devices 104-1 through 104-7 (referred to individually as “wireless device 104” or collectively as “wireless devices 104”) and a core network 106. The wireless devices 104-1 through 104-7 can correspond to or include network 100 entities capable of communication using various connectivity standards. For example, a 5G communication channel can use millimeter wave (mmW) access frequencies of 28 GHz or more. In some implementations, the wireless device 104 can operatively couple to a base station 102 over a long-term evolution/long-term evolution-advanced (LTE/LTE-A) communication channel, which is referred to as a 4G communication channel.

The core network 106 provides, manages, and controls security services, user authentication, access authorization, tracking, Internet Protocol (IP) connectivity, and other access, routing, or mobility functions. The base stations 102 interface with the core network 106 through a first set of backhaul links (e.g., S1 interfaces) and can perform radio configuration and scheduling for communication with the wireless devices 104 or can operate under the control of a base station controller (not shown). In some examples, the base stations 102 can communicate with each other, either directly or indirectly (e.g., through the core network 106), over a second set of backhaul links 110-1 through 110-3 (e.g., X1 interfaces), which can be wired or wireless communication links.

The base stations 102 can wirelessly communicate with the wireless devices 104 via one or more base station antennas. The cell sites can provide communication coverage for geographic coverage areas 112-1 through 112-4 (also referred to individually as “coverage area 112” or collectively as “coverage areas 112”). The geographic coverage area 112 for a base station 102 can be divided into sectors making up only a portion of the coverage area (not shown). The network 100 can include base stations of different types (e.g., macro and/or small cell base stations). In some implementations, there can be overlapping geographic coverage areas 112 for different service environments (e.g., Internet-of-Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 100 can include a 5G network 100 and/or an LTE/LTE-A or other network. In an LTE/LTE-A network, the term eNB is used to describe the base stations 102, and in 5G new radio (NR) networks, the term gNBs is used to describe the base stations 102 that can include mmW communications. The network 100 can thus form a heterogeneous network 100 in which different types of base stations provide coverage for various geographic regions. For example, each base station 102 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 100 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 100 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 100 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a wireless device 104 and the base stations 102 or core network 106 supporting radio bearers for the user plane data. At the Physical (PHY) layer, the transport channels are mapped to physical channels.

Wireless devices can be integrated with or embedded in other devices. As illustrated, the wireless devices 104 are distributed throughout the wireless telecommunications network 100, where each wireless device 104 can be stationary or mobile. For example, wireless devices can include handheld mobile devices 104-1 and 104-2 (e.g., smartphones, portable hotspots, tablets, etc.); laptops 104-3; wearables 104-4; drones 104-5; vehicles with wireless connectivity 104-6; head-mounted displays with wireless augmented reality/virtual reality (ARNR) connectivity 104-7; portable gaming consoles; wireless routers, gateways, modems, and other fixed-wireless access devices; wirelessly connected sensors that provides data to a remote server over a network; IoT devices such as wirelessly connected smart home appliances, etc.

A wireless device (e.g., wireless devices 104-1, 104-2, 104-3, 104-4, 104-5, 104-6, and 104-7) can be referred to as a user equipment (UE), a user device, a customer premise equipment (CPE), a mobile station, a mobile device, a subscriber station, a mobile unit, a subscriber unit, a wireless unit, a remote unit, a handheld mobile device, a remote device, a mobile subscriber station, terminal equipment, an access terminal, a mobile terminal, a wireless terminal, a remote terminal, a handset, a mobile client, a client, or the like.

A wireless device can communicate with various types of base stations and network 100 equipment at the edge of a network 100 including macro eNBs/gNBs, small cell eNBs/gNBs, relay base stations, and the like. A wireless device can also communicate with other wireless devices either within or outside the same coverage area of a base station via device-to-device (D2D) communications.

The communication links 114-1 through 114-9 (also referred to individually as “communication link 114” or collectively as “communication links 114”) shown in network 100 include uplink (UL) transmissions from a wireless device 104 to a base station 102, and/or downlink (DL) transmissions from a base station 102 to a wireless device 104. The downlink transmissions can also be called forward link transmissions while the uplink transmissions can also be called reverse link transmissions. Each communication link 114 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 114 can transmit bidirectional communications using frequency division duplex (FDD) (e.g., using paired spectrum resources) or time division duplex (TDD) operation (e.g., using unpaired spectrum resources). In some implementations, the communication links 114 include LTE and/or mmW communication links.

In some implementations of the network 100, the base stations 102 and/or the wireless devices 104 include multiple antennas for employing antenna diversity schemes to improve communication quality and reliability between base stations 102 and wireless devices 104. Additionally, or alternatively, the base stations 102 and/or the wireless devices 104 can employ multiple-input, multiple-output (MIMO) techniques that can take advantage of multi-path environments to transmit multiple spatial layers carrying the same or different coded data.

In some examples, the network 100 implements 6G technologies including increased densification or diversification of network nodes. The network 100 can enable terrestrial and non-terrestrial transmissions. In this context, a Non-Terrestrial Network (NTN) is enabled by one or more satellites such as satellites 116-1 and 116-2 to deliver services anywhere and anytime and provide coverage in areas that are unreachable by any conventional Terrestrial Network (TN). A 6G implementation of the network 100 can support terahertz (THz) communications. This can support wireless applications that demand ultra-high quality of service requirements and multi-terabits per second data transmission in the 6G and beyond era, such as terabit-per-second backhaul systems, ultrahigh-definition content streaming among mobile devices, AR/VR, and wireless high-bandwidth secure communications. In another example of 6G, the network 100 can implement a converged Radio Access Network (RAN) and Core architecture to achieve Control and User Plane Separation (CUPS) and achieve extremely low User Plane latency. In yet another example of 6G, the network 100 can implement a converged Wi-Fi and Core architecture to increase and improve indoor coverage.

### Flexible Routing Control

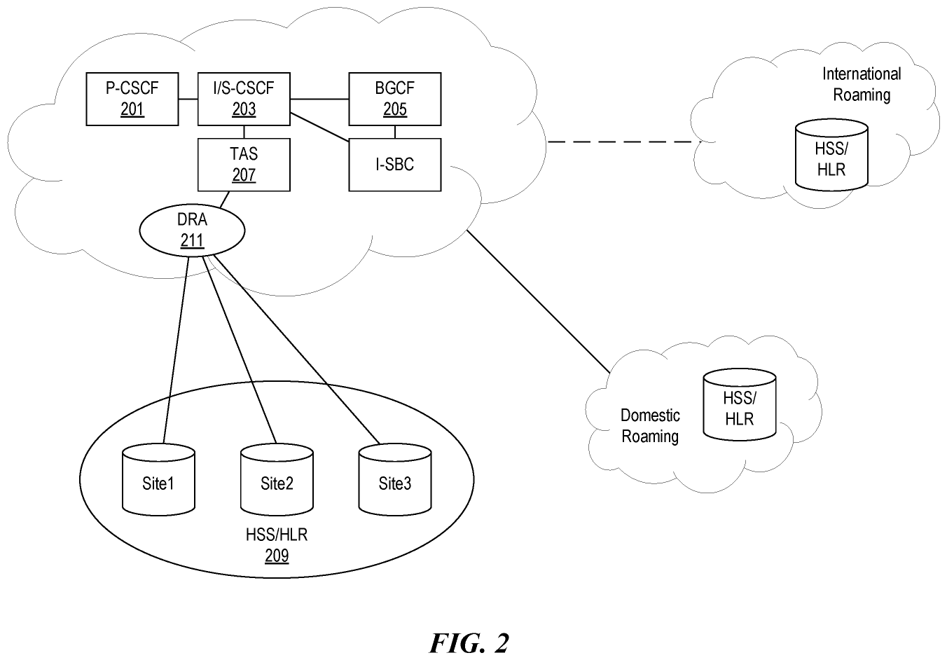

Historically, mobile phones have provided voice call services to user over a circuit-switched-style network, such as the public switched telephone network (PSTN), rather than over an IP packet-switched network. To enable delivery of IP multimedia services, the IP Multimedia Subsystem or IP Multimedia Core Network Subsystem (IMS) has been introduced as an architectural framework, which uses the Session Initiation Protocol (SIP) protocol to initiate, maintain, and terminate real-time sessions that include voice, video and messaging applications. The SIP is used for signaling and controlling multimedia communication sessions in applications of Internet telephony for voice and video calls, in private IP telephone systems, in instant messaging over IP networks as well as voice calling over Long-Term Evolution (VoLTE) or New Radio (VoNR). FIG. 2 illustrates an example architecture an IMS network. Some of the network functions provided by the IMS include:

### 1. Call Session Control Function (CSCF).

1a. A Proxy-CSCF (P-CSCF) 201 is a SIP proxy that is the first point of contact for the IMS terminal.

1b. An Interrogating-CSCF (I-CSCF) or a Serving-CSCF (S-CSCF) 203 is another SIP function located of an administrative domain. Its IP address is published in the Domain Name System (DNS) of the domain so that remote servers can find it, and use it as a forwarding point (e.g., registering) for SIP packets to this domain.

### 2. A Breakout Gateway Control Function (BGCF).

The BGCF 205 is a SIP proxy that processes requests for routing from a I/S-CSCF 203 when it has determined that the session cannot be routed using DNS or Electronic Numbering (ENUM) lookups (ENUM)/DNS. It includes routing functionality based on telephone numbers.

### 3. Telephony Application Server (TAS).

The TAS 207 is a component used in the core network of a network operator to provide telephony applications and additional multimedia functions.

### 4. A Home Subscriber Server (HSS)/Home Location Register (HLR).

The HSS/HLR 209 is a centralized database of subscriber information that allows Communications Service Providers (CSPs) to manage customers in real-time and in a cost-effective manner. The HSS/HLR can be in connection with the TAS via the Diameter Routing Agent (DRA) 211.

In the event of network outage that impacts the S-CSCF, all users registered on the S-CSCF can encounter registration (REG), re-registration (re-REG), mobile originating (MO) and mobile terminating (MT) call failures. Currently, if the UE initiates an originating service request after SIP registration and the P-CSCF is unable to contact the S-CSCF, the P-CSCF returns a specific error response to the UE to trigger a new registration. In UE terminating procedures, when the I-CSCF is unable to contact the S-CSCF during terminating procedure, the I-CSCF requests S-CSCF capabilities from the HSS/HLR. If the HSS returns the S-CSCF capabilities to the I-CSCF, after re-selection of another S-CSCF according to the S-CSCF capabilities, the I-CSCF forwards the service request to the new S-CSCF. The new S-CSCF can provide S-CSCF restoration information to the HSS. If the S-CSCF restoration information received includes the UE's subscription information, the new S-CSCF constructs a NOTIFY message according to the information and send it to the UE to trigger a new registration. In both mobile originating and terminating cases, the new registration procedures can cause extra delay in call handling and lead to deteriorating user experience.

This patent document discloses techniques that can be implemented in various embodiments to provide flexible routing options to enable efficient routing and call establishments when the S-CSCF becomes unavailable, without the need to trigger new registration procedures. The disclosed techniques can be implemented to reduce call handling delays and minimize signaling overhead. When a network event causes a network node (e.g., S-CSCF) to become unavailable, a new network node (e.g., a new S-CSCF) can handle the request as part of flexible routing control procedure. In such scenarios, if there is a terminating mobile call or session handled by a TAS, the TAS can determine whether the call or the session should be routed using the CS domain or using other routing options. For example, if the home network doesn't support CS domain, the TAS can by-pass the CS routing by directly invoking the call forwarding, thereby avoiding the triggering of a new registration after the call ended.

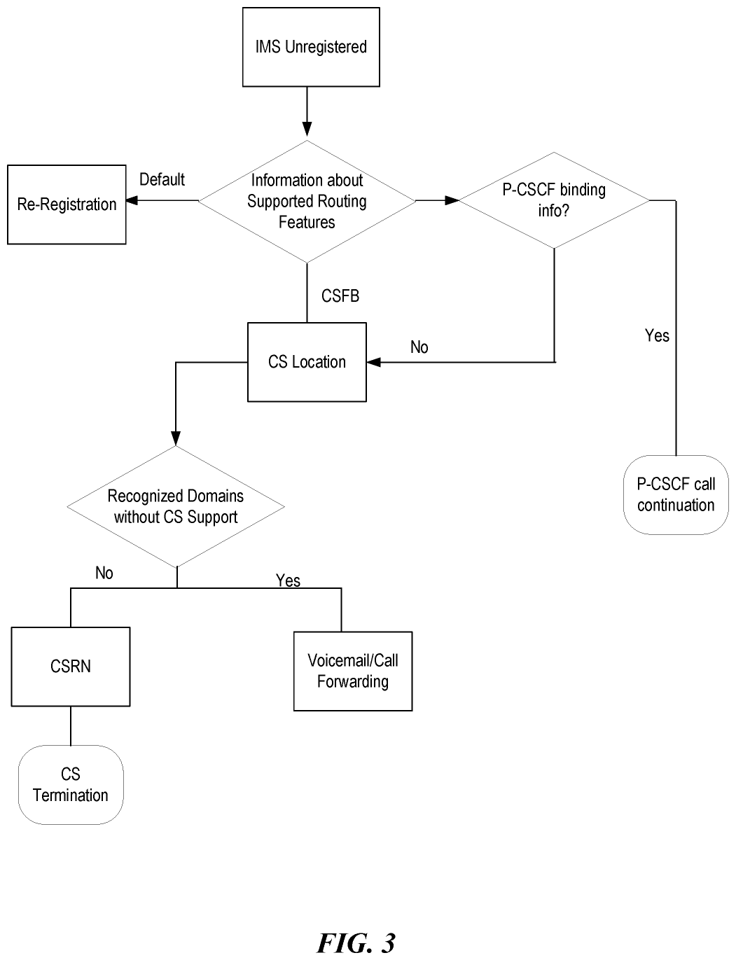

FIG. 3 is a flow diagram of an example of flexible routing options in accordance with one or more embodiments of the present technology. In some embodiments, the example steps shown in FIG. 3 can be implemented on the TAS to make routing decisions. When network outage impacts the S-CSCF, the secure association between the network nodes (e.g., P-CSCF) and the user device or the user registration information may not be recoverable, causing call requests to be treated as IMS unregistered requests (e.g., request to unregistered users). Upon receiving an IMS unregistered request, instead of triggering a new registration, a re-registration, or an invite procedure, the network can examine the supported routing features and determine if alternative routing options can be provided to reduce signaling overhead or delay. The additional routing features can be indicated using information in the user profile, such as a tag or a field in the user profile XML document. The TAS can make the routing decisions based on the information included in the XML and retrieve necessary information from the HSS, its local cache, and/or an external cache/database that it has access to. For example, the additional routing features can enable the network to continue to route the IMS unregistered request using existing binding information. As another example, the additional routing features can enable the use of the circuit switched (CS) network as a fallback routing option. In some embodiments, the CS Fallback procedure triggers a new registration after session handled in the CS is ended.

In some embodiments, instead of triggering a re-registration or an invite, a fallback to the CS network can be performed. This fallback is referred to as Circuit Switched Fallback (CSFB) and is seen as an interim solution for network operators. For CSFB, the TAS checks for the CS Domain Routing Number (CSRN) to deliver the call or the message as part of the CS retry mechanism. As shown in FIG. 3, when CSFB routing option is enabled as part of the routing features, the network can determine the CS location of the subscriber device (e.g., the mobile switching center location of the subscriber device) and route the communication using the CS networks, e.g., by checking the CSRN value.

In some cases, with development in VoIP technologies, the use of the CS networks (e.g., the 2G and 3G networks) can be slowly phased out by the network operators. When the support for CSFB becomes obsolete for at least parts of the network, the consistent checking of the CSRN can lead to unnecessary signaling overhead and waste of network resources. In those cases, the CSFB routing option can include additional information about the known/recognized domains in which CS support has been phased out. If the CS location of the subscriber device falls in one of the recognized domains, the call can be directed to voicemail or according to user-defined calling forward mechanism(s) without initiating an attempt for a CS retry. If the CS location is outside of the recognized domains, a CS retry attempt can be initiated using the CSRN value.

In some embodiments, the routing features can include support for the recovery of the secure association between the user device and the P-CSCF (also referred to as P-CSCF binding information) so that the newly selected S-CSCF can continue routing the communication (e.g., for mobile terminating calls) using the recovered P-CSCF information. The TAS can check if the P-CSCF binding information can be found in its local cache or in an external database that it has access to. Alternatively, or in addition, the P-CSCF and/or the newly selected S-CSCF can request the P-CSCF binding information from the HSS/HLR. If the information is not found, the TAS/S-CSCF can fall back to circuit switched support for handling the call.

In some embodiments, the routing options can be stored in the HSS/HLR and exchanged between the HSS/HLR and other network nodes (e.g., I-CSCF, TAS) to enable the continuation of routing the current communication without trigger a new registration procedure. For example, the routing options can be added to the user profile that is stored on the HSS/HLR. The user profile can be implemented as an Extensible Markup Language (XML) document that includes different parts such as public identification, core network service authorization, and the initial filter criteria. Table 1 shows an example user profile that includes routing options in accordance with one or more embodiments of the present technology. Alternatively, or in addition, the user profile can be implemented using a table format including entries for information such as public identification, core network service authorization, and/or the initial filter criteria.

TABLE 1
Example Routing Options in User Profile

```
<?xml version=“1.0” encoding=“UTF-8”?>
<tns:users>
<tns:user>
  <authenticationType>BASIC</authenticationType>
  <commProfileSet>
  ...
  </commProfileSet>
  <routingAdvancedOptions>
    <CSFB>
      <enabled>Y</enabled>
      <DomainRangeinVLR>86-139-0000:86-139-0999</DomainRangeinVLR>
    </CSFB>
    <BindingInformation>
      <retrievable>Y</retrievable>
      <cache>N</cache>
      <database>128.0.0.1</database>
    </BindingInformation>
  </routingAdvancedOptions>
</tns:user>
</tns:users>
```

In some embodiments, the HSS/HLR transfers the user profile that includes the flexible routing options to other network nodes (e.g., S-CSCF, TAS) so that the other network nodes can make appropriate routing decisions. In some embodiments, the flexible routing options can be stored locally or externally to a network node (e.g., TAS) to allow easy access of the routing information. For example, the routing options can be stored in the local cache of the TAS, or in an external database that is accessible to the TAS. The TAS can provide the stored routing option to the newly selected S-CSCF when needed.

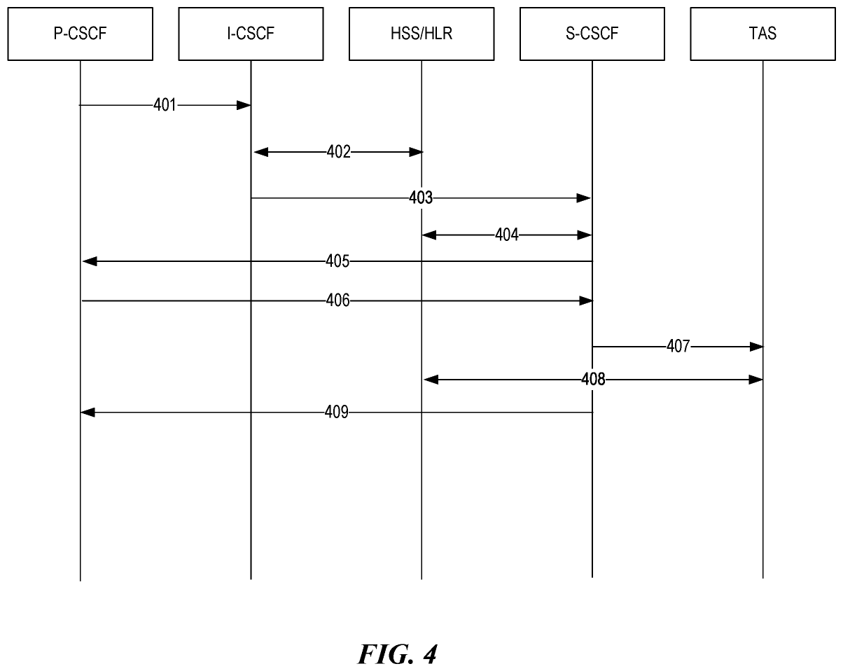

FIG. 4 illustrates an example SIP registration call flow in accordance with one or more embodiments of the present technology.

Operation 401: The P-CSCF transmits an SIP Registration request (e.g., SIP REG) to the I-CSCF.

Operation 402: The I-CSCF and the HSS/HLR exchange User-Authorization-Request (UAR) and User-Authorization-Answer (UAA) messages to validate the user device and to return a selected S-CSCF based on S-CSCF capabilities.

Operation 403: The I-CSCF forwards the SIP REG request to the selected S-CSCF.

Operation 404: The HSS/HLR and the S-CSCF exchange Multimedia Authentication Request (MAR) and Multimedia Authentication Answer (MAA) messages to retrieve the authentication vectors for IMS security measures. The HSS/HLR stores the S-CSCF information.

Operation 405: The S-CSCF challenges the UE by transmitting a 401 Unauthorized message via the P-CSCF.

Operation 406: The P-CSCF allocates ciphering and integrity key(s) to the UE. These keys are needed for establishing a security association between the P-CSCF and the UE. Such security association is also referred to as P-CSCF binding information. The P-CSCF then establishes a secure connection with the UE (e.g., TLS connection or IPsec). For example, the Authentication and Key Agreement (AKA) authentication ensures all traffic between UE and P-CSCF during a session is sent on IPsec-protected channels. Subsequently, the P-CSCF forwards a new SIP REG request from the UE to the S-CSCF via the I-CSCF.

Operation 407: The S-CSCF checks if there is a match between the two SIP REG requests and forwards SIP REG to the TAS.

Operation 408: The TAS exchanges Subscribe-Notifications-Request (SNR) and Subscribe-Notifications-Answer (SNA) messages with the HSS/HLR to retrieve the user profile. Alternatively, or in addition, the TAS can send Profile-Update-Request to update the user profile. The user profile includes the applicable routing options for routing subsequent communications for the UE. For example, the routing options indicate at least one of: (1) whether a circuit switched fallback of routing the communication is available, (2) a recognized domain in which the circuit switched fallback is not supported, and/or (3) whether binding information between the P-CSCF and the user device is stored and/or retrievable. The information about the routing options can be stored at the time of the SIP registration. In some embodiments, the TAS can retrieve the information on the fly in case of unregistered service handling.

Operation 409: The S-CSCF passes a 200 OK message to the P-CSCF via the I-CSCF.

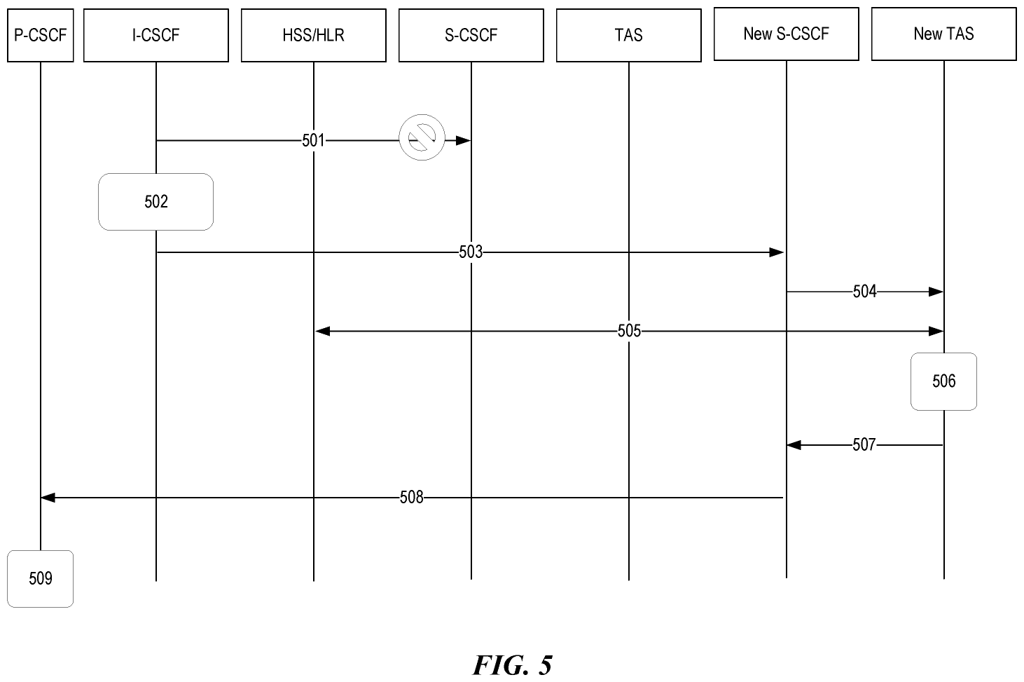

FIG. 5 illustrates an example SIP call flow when the S-CSCF becomes unreachable in accordance with one or more embodiments of the present technology. As part of the IMS registration process, the P-CSCF stores the service-route address (e.g., S-CSCF address). A session-initiated P-CSCF (e.g., with mobile originating/mobile terminating calls or messages) communicates with the S-CSCF directly. When the S-CSCF becomes unreachable, the P-CSCF enables the I-CSCF to select a new S-CSCF at Operation 501. The I-CSCF can select a new S-CSCF at Operation 502 and send a routing invite to the newly selected S-CSCF at Operation 503. At Operation 504, the newly selected S-CSCF can forwards the routing invite to a new TAS or the original TAS at operation 503. In some embodiments, the TAS can exchange SNR/SNA messages with the HSS/HLR at operation 505 to download the user profile that includes the different routing options. In some embodiments, the TAS can search for such routing information in its local cache or an external data storage location at Operation 506. Upon receiving the routing options, the TAS can forward the options to the newly selected S-CSCF so that the S-CSCF can determine the best routing option to handle the communication based on the specific call/message scenario(s). For example, in the specific case shown in FIG. 5, the TAS retrieves and forwards the routing information along with the P-CSCF binding information to the newly selected S-CSCF at Operation 507. The S-CSCF decides to continue the routing of the current communication using the P-CSCF binding information. The S-CSCF transmits an SIP invite to the P-CSCF using the P-CSCF binding information at Operation 508. Upon receiving the SIP invite, the P-CSCF can create a new S-CSCF binding for the duration of the call at Operation 509 such that the mobile-terminating call can be successfully completed.

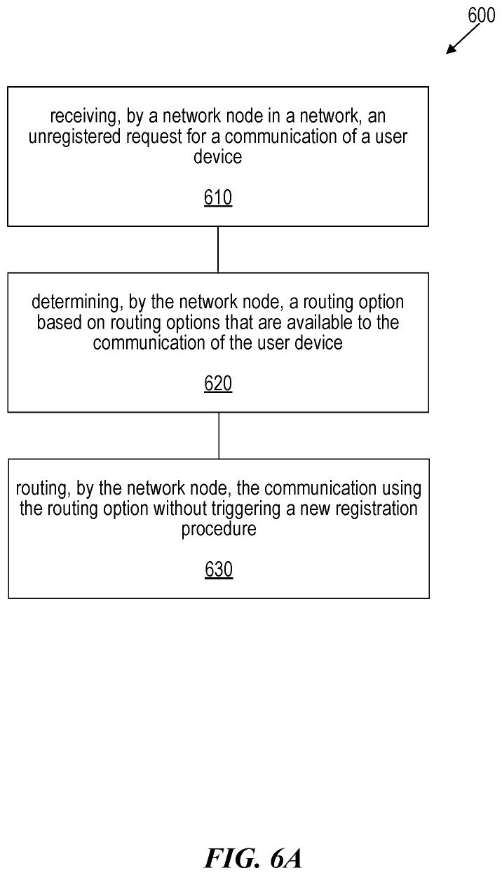

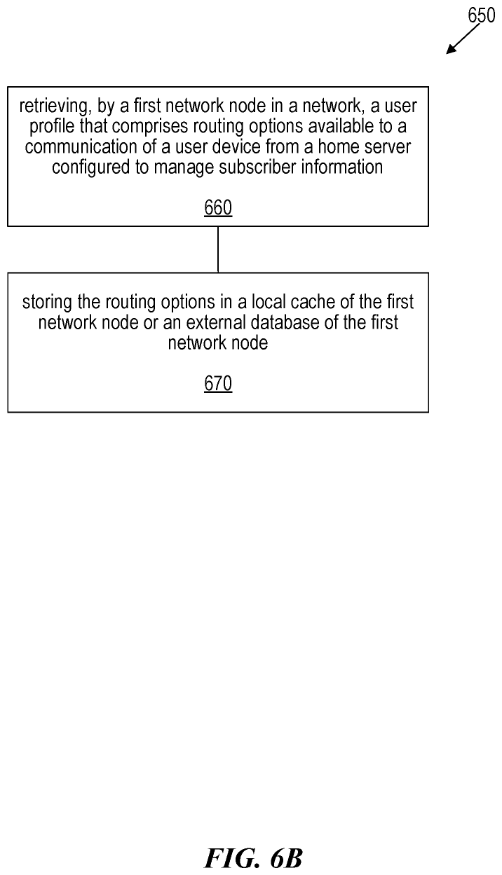

FIG. 6A is a flowchart representation of a method or a process of wireless communication in accordance with one or more embodiments of the present technology. The process 600 includes, at operation 610, receiving, by a network node in a network, an unregistered request for a communication of a user device. The process 600 includes, at operation 620, determining, by the network node, a routing option based on routing options that are available to the communication of the user device. The routing options indicate at least one of: (1) whether a circuit switched fallback of routing the communication is available, (2) a recognized domain in which the circuit switched fallback is not supported, or (3) whether binding information between a P-CSCF and the user device is stored and/or retrievable (e.g., as shown in Table 1). In some embodiments, the routing options can include information indicating that the home network is one of the recognized domains that do not support the circuit switched fallback. The routing options can further include information indicating that the circuit switched fallback is allowed when the user device is not in the home network. The process 600 also includes, at operation 630, routing, by the network node, the communication using the routing option without triggering a new registration procedure.

In some embodiments, the routing options that are available to the communication are stored in a user profile associated with the user device. In some embodiments, the process includes receiving, by the network node, the user profile from a home server configured to manage subscriber information. The user profile can be implemented as an XML document or a document in a table format.

In some embodiments, the process includes receiving, by the network node, the routing options that are available to the communication from a telephonic application server (TAS). The routing options can be stored in a local cache of the TAS or an external database accessible to the TAS. The routing options include whether the binding information is stored in a local cache of the TAS or an external data storage location accessible to the TAS.

FIG. 6B is a flowchart representation of a method or a process of wireless communication in accordance with one or more embodiments of the present technology. The process 650 includes, at operation 660, retrieving, by a first network node in a network, a user profile that comprises routing options available to a communication of a user device from a home server configured to manage subscriber information. The routing options indicate at least one of: (1) whether a circuit switched fallback of routing the communication is available, (2) a recognized domain in which the circuit switched fallback is not supported, or (3) whether binding information between a P-CSCF and the user device is stored and/or retrievable. The routing options can include whether the binding information is stored in the local cache of the first network node or the external database of the first network node. (e.g., see Table 1). The process 650 includes, at operation 670, storing the routing options in a local cache of the first network node or an external database of the first network node.

In some embodiments, the process includes transmitting, by the first network node, the routing options to a second network node in the network to enable the second network node to route the communication without triggering a new registration procedure. In some embodiments, the second network node comprises a new S-CSCF that is selected upon an original S-CSCF being unreachable to other network nodes in the network.

### Computer System

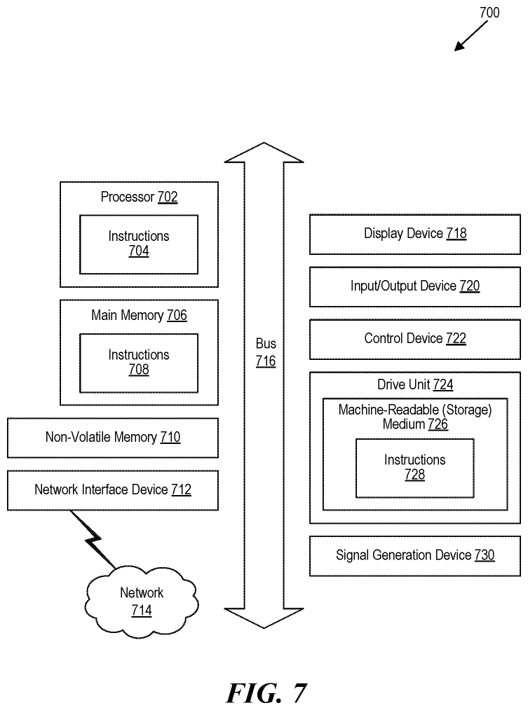

FIG. 7 is a block diagram that illustrates an example of a computer system 700 in which at least some operations described herein can be implemented. As shown, the computer system 700 can include: one or more processors 702, main memory 706, non-volatile memory 710, a network interface device 712, video display device 718, an input/output device 720, a control device 722 (e.g., keyboard and pointing device), a drive unit 724 that includes a storage medium 726, and a signal generation device 730 that are communicatively connected to a bus 716. The bus 716 represents one or more physical buses and/or point-to-point connections that are connected by appropriate bridges, adapters, or controllers. Various common components (e.g., cache memory) are omitted from FIG. 7 for brevity. Instead, the computer system 700 is intended to illustrate a hardware device on which components illustrated or described relative to the examples of the figures and any other components described in this specification can be implemented.

The computer system 700 can take any suitable physical form. For example, the computing system 700 can share a similar architecture as that of a server computer, personal computer (PC), tablet computer, mobile telephone, game console, music player, wearable electronic device, network-connected (“smart”) device (e.g., a television or home assistant device), ARNR systems (e.g., head-mounted display), or any electronic device capable of executing a set of instructions that specify action(s) to be taken by the computing system 700. In some implementation, the computer system 700 can be an embedded computer system, a system-on-chip (SOC), a single-board computer system (SBC) or a distributed system such as a mesh of computer systems or include one or more cloud components in one or more networks. Where appropriate, one or more computer systems 700 can perform operations in real-time, near real-time, or in batch mode.

The network interface device 712 enables the computing system 700 to mediate data in a network 714 with an entity that is external to the computing system 700 through any communication protocol supported by the computing system 700 and the external entity. Examples of the network interface device 712 include a network adaptor card, a wireless network interface card, a router, an access point, a wireless router, a switch, a multilayer switch, a protocol converter, a gateway, a bridge, bridge router, a hub, a digital media receiver, and/or a repeater, as well as all wireless elements noted herein.

The memory (e.g., main memory 706, non-volatile memory 710, machine-readable medium 726) can be local, remote, or distributed. Although shown as a single medium, the machine-readable medium 726 can include multiple media (e.g., a centralized/distributed database and/or associated caches and servers) that store one or more sets of instructions 728. The machine-readable (storage) medium 726 can include any medium that is capable of storing, encoding, or carrying a set of instructions for execution by the computing system 700. The machine-readable medium 726 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory devices 710, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 704, 708, 728) set at various times in various memory and storage devices in computing device(s). When read and executed by the processor 702, the instruction(s) cause the computing system 700 to perform operations to execute elements involving the various aspects of the disclosure.

### Remarks

The terms “example”, “embodiment” and “implementation” are used interchangeably. For example, reference to “one example” or “an example” in the disclosure can be, but not necessarily are, references to the same implementation; and, such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described which can be exhibited by some examples and not by others. Similarly, various requirements are described which can be requirements for some examples but no other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples, but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a mean-plus-function claim will use the words “means for.” However, the use of the term “for” in any other context is not intended to invoke a similar interpretation. The applicant reserves the right to pursue such additional claim forms in either this application or in a continuing application.

What is claimed is:

1. A system for wireless communication, comprising:
a Proxy Call Session Control Function (P-CSCF) that is in communication with a mobile device in a network;
a first Serving Call Session Control Function (S-CSCF) configured to handle a first part of a communication with the mobile device;
a Telephony Application Server (TAS) configured to store information about routing options that are available to the communication of the mobile device; and
a second S-CSCF that is selected upon the first S-CSCF being unreachable to other network nodes in the network, wherein the second S-CSCF is configured to:
receive an unregistered request for a remaining part of the communication with the mobile device;
determine a routing option based on the routing options that are available to the communication with the mobile device,
wherein the routing options indicate at least one of:
(1) whether a circuit switched fallback of routing the communication is available,
(2) a recognized domain in which the circuit switched fallback is not supported, or
(3) whether binding information between the P-CSCF and the mobile device is stored or retrievable, and
route the communication using the routing option without triggering a new registration procedure.

2. The system of claim 1, wherein the routing options that are available to the communication are stored in a user profile associated with the mobile device.

3. The system of claim 2, wherein the second S-CSCF is configured to:
receive the user profile from a home server configured to manage subscriber information.

4. The system of claim 2, wherein the TAS is configured to:
receive the user profile from a home server configured to manage subscriber information; and
store the information about the routing options in a local cache of the TAS or an external database accessible to the TAS.

5. The system of claim 2, wherein the user profile is implemented as an Extensible Markup Language (XML) document, and wherein the routing options that are available to the communication of the mobile device are indicated using one or more entries in the XML document.

6. The system of claim 1, wherein the second S-CSCF is configured to:
receive, from the TAS, the routing options that are available to the communication of the mobile device.

7. A method for wireless communication, comprising:
receiving, by a network node in a network, an unregistered request for a communication of a user device;
determining, by the network node, a routing option based on routing options that are available to the communication of the user device,
wherein the routing options indicate at least one of:
(1) whether a circuit switched fallback of routing the communication is available,
(2) a recognized domain in which the circuit switched fallback is not supported, or
(3) whether binding information between a Proxy Call Session Control Function (P-CSCF) and the user device is stored or retrievable, and
routing, by the network node, the communication using the routing option without triggering a new registration procedure.

8. The method of claim 7, wherein the routing options that are available to the communication are stored in a user profile associated with the user device.

9. The method of claim 8, comprising:
receiving, by the network node, the user profile from a home server configured to manage subscriber information.

10. The method of claim 8, wherein the user profile is implemented as an Extensible Markup Language (XML) document.

11. The method of claim 7, comprising:
receiving, by the network node, the routing options that are available to the communication from a telephonic application server (TAS).

12. The method of claim 11, wherein the routing options are stored in a local cache of the TAS or an external database accessible to the TAS.

13. The method of claim 11, wherein the routing options include whether the binding information is stored in a local cache of the TAS or an external database accessible to the TAS.

14. The method of claim 7, wherein the network node comprises a Serving CSCF.

15. A method of wireless communication, comprising:
retrieving, by a first network node in a network, a user profile that comprises routing options available to a communication of a user device from a home server configured to manage subscriber information,
wherein the routing options indicate at least one of:
(1) whether a circuit switched fallback of routing the communication is available,
(2) a recognized domain in which the circuit switched fallback is not supported, or
(3) whether binding information between a Proxy Call Session Control Function (P-CSCF) and the user device is stored or retrievable,
storing the routing options in a local cache of the first network node or an external database of the first network node.

16. The method of claim 15, comprises:
transmitting, by the first network node, the routing options to a second network node in the network to enable the second network node to route the communication without triggering a new registration procedure.

17. The method of claim 16, wherein the second network node comprises a new Serving Call Session Control Function (S-CSCF) that is selected upon an original S-CSCF being unreachable to other network nodes in the network.

18. The method of claim 15, wherein the routing options include whether the binding information is stored in the local cache of the first network node or the external database of the first network node.

19. The method of claim 15, wherein the home server comprises a Home Subscriber Sever (HSS) or a Home Location Register (HLR).

20. The method of claim 15, wherein the first network node comprises a telephonic application server (TAS).
